(19) United States
(12) Patent Application Publication
(10) Pub. No.: US 2017/0091605 A1
(43) Pub. Date: Mar. 30, 2017

(54) Editable Intelligent 2-dimensional Bar Code

(71) Applicant: Xiaoqun Gao, Xi'an City (CN)

(72) Inventor: Xiaoqun Gao, Xi'an City (CN)

(21) Appl. No.: 14/869,571

(22) Filed: Sep. 29, 2015

(51) Int. Cl. G06K 19/06

(52) U.S. Cl. CPC G06K 19/0615; G06K 19/06037

(57) ABSTRACT

This invention is about an editable intelligent 2-dimensional bar code which allows vacant code assignment and allows the users to modify the content for certain purposes at any time; It also has video, audio, image and character functions; The editing interface is clear and simple. The intelligent 2-dimensional bar code has an independent editing and operating platform and background so that it easy to edit and operate. Moreover, it has two editing modes, modular mode and free mode. This invention is the first intelligent 2-dimensional bar code that is editable for users. People who are allowed to acquire the information can acquire the latest information by scanning the code.

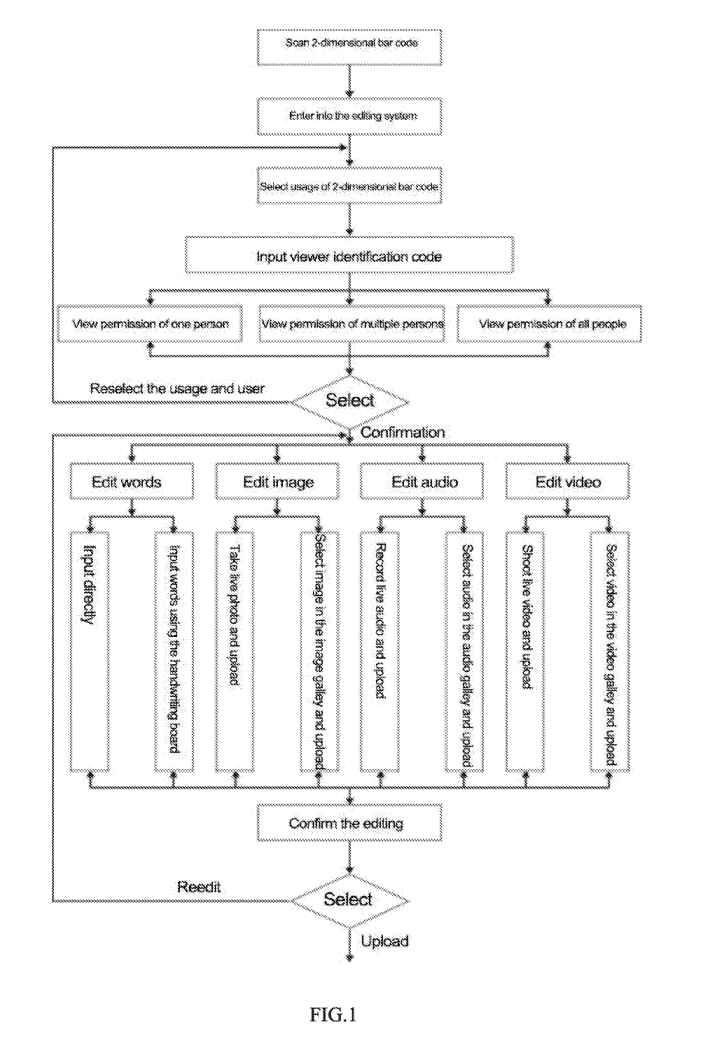

### TECHNOLOGY FIELD

This invention is an intelligent 2-dimensional bar code editable for users.

### BACKGROUND TECHNOLOGY

2-dimensional bar code is a black and white pattern formed with certain geometric figures distributing on the plane (two dimensional direction) regularly so as to record data and symbol information; speaking of code compiling, it uses the concept of “0” and “1” bit stream, internal logic basis of computer skillfully so as to use several geometric figures corresponding to the binary system to express the text in numerical information. Image input devices or optoelectronic scanning devices can read the code automatically, which makes automatic information processing possible; it has some general features of bar code technology. Each code order has its specific character set; each character has a certain width; it has verification function. In addition, it can identify information in different lines automatically and process rotation and change points of figures.

China's study on 2-dimensional bar code technology started in 1993. Article Numbering Center of China (ANCC) made translation and tracking research on technology standards of some common 2-dimensional bar codes such as PDF417, QRCCode, Data Matrix, Maxi Code, Code 49, Code 16K and Code One. As Chinese market economy develops continuously and the information technology upgrades rapidly, domestic demand on 2-dimensional bar code technology keeps increasing. With the strong support of the former State Bureau of Quality Technical Supervision and other relevant national departments, ANCC kept deepening their study on 2-dimensional bar code technology. Besides analyzing foreign technical data, it formulated two national standards on 2-dimensional bar code, namely Two-dimensional Barcode—Grid Matrix Code (SJ/T 11349-2006) and Two-dimensional Barcode—Complex Matrix (CM) Code (SJ/T 11350-2006). Thus, China's research and development on 2-dimensional bar code with proprietary intellectual property rights has been greatly promoted.

Now, 2-dimensional bar codes on the market have the following defects.

1. The most common material is paper;

2. There are only a few information forms, mainly text and picture;

3. There is no individualized part. After the 2-dimensional bar code is generated, the content is fixed. The user cannot modify it as needed;

4. There is no interactive information communication between the user and the information acquirers.

### INVENTION CONTENT

This editable intelligent bar code is to remove all defects of the existing technology.

This invention is made based on the following scheme.

This is an editable intelligent 2-dimensional bar code. It allows vacant code assignment. The user can modify the content at any time as needed. The users can modify the content for certain purposes at any time

It has video, audio, image and text functions;

The editing interface of the 2-dimensional bar code is clear and simple. It also has an independent editing and operating platform and background. It is easy to edit and operate. It has two editing modes, modular mode and free mode.

Information of the 2-dimensional code can be passed in real time. The users can edit and modify the content at any time. People who are allowed to acquire the information can see the changes immediately.

The 2-dimensional bar code information has high security. The user can set that the content is only accessible to certain people. Others will neither read nor edit the content after scanning the code. It guarantees confidentiality and security of information transfer.

The 2-dimensional bar code is applicable to paper, metal, plastic, wood, ceramic, porcelain, stone and red stoneware.

Usage of the 2-dimensional bar code includes the following steps.

Step 1: generate an editable intelligent 2-dimensional bar code randomly by the 2-dimensional bar code system background;

Step 2: make the 2-dimensional bar code on necessary materials in different forms of presentation and application;

Step 3: by scanning the code with the mobile device, the user will see the editing login interface.

The 2-dimensional bar code has the following forms of presentation and application.
(1) Print the 2-dimensional bar code on all kinds of materials by directly using the printing technology;
(2) Make code on metal materials by using luminance difference between glossy face and the rough face of the metal;
(3) Carve the code on the material surface;
(4) Engrave the code on relevant materials by using hollow-cutting technique;
(5) Inlay or paste the code on other materials by using inlaying technique;
(6) Burn the 2-dimensional bar code pattern on relevant materials by suing the technique of laser engraving.

Step 1, generating an editable intelligent 2-dimensional bar code, includes the following specific procedures.

A. The user inputs the application type. Input one or more pieces of identifying information people who are allowed to acquire the information. Then, the user can enter the editing page;

B. The user can edit the content based on the requirements or can select relevant editing template to make individualized content of the intelligent two-dimensional code;

C. The user can add video or audio files as needed;

D. The user can add, cut or modify the images or text as needed;

E. After editing, the user can “click issuing”. People who are allowed to acquire the information can view it by scanning the code with their mobile devices.

The application types include birthday congratulations, holiday greetings, wedding wishes and graduation congratulations;

Identifying information includes WeChat ID, ID card, telephone number and email address.

Benefits of this invention are as follows.

1. This invention is the first intelligent 2-dimensional bar code that is editable for users and allows vacant code assignment. The users can modify the content for certain purposes at any time, and people who are allowed to acquire the information can view it immediately by scanning the code;

2. This invention is an editable intelligent 2-dimensional bar code which upgrades the information amount and the information types of common 2-dimensional bar code. It gives 2-dimensional bar code many functions like video, audio, image and text so that it can fully meet the users' requirements;

3. This invention gives a simple interface to edit the 2-dimensional bar code. The editing interface is clear and simple. It also has an independent editing and operating platform and background. It is easy to edit and operate. It has two editing modes, modular mode and free mode. Even people who are not familiar with network information editing can master it easily;

4. Information of the 2-dimensional code can be passed in real time. The users can edit and modify the content at any time. People who are allowed to acquire the information can see the changes immediately;

5. The 2-dimensional bar code information has high security. The user can set that the content is only accessible to certain people. Others will neither read nor edit the content after scanning the code. It guarantees confidentiality and security of information transfer.

### Specific Implementing Ways

The following is a further explanation of the invention combining with embodiments.

This invention is the first intelligent 2-dimensional bar code that is editable for users and allows vacant code assignment. The users can modify the content for certain purposes at any time, and people who are allowed to acquire the information can view it immediately by scanning the code.

This invention is an editable intelligent 2-dimensional bar code which upgrades the information amount and the information types of common 2-dimensional bar code. It gives 2-dimensional bar code many functions like video, audio, image and text so that it can fully meet the users' requirements;

The editing interface of the 2-dimensional bar code is clear and simple. It has an independent editing and operating platform and background so that is easy to edit and operate. It has two editing modes, modular mode and free mode. Even people who are not familiar with network information editing can master it easily.

Information of the 2-dimensional code can be passed in real time. The users can edit and modify the content at any time, and people who are allowed to acquire the information can see the changes immediately.

The 2-dimensional bar code information has high security. The user can set that the content is only accessible to certain people. Others will neither read nor edit the content after scanning the code. It guarantees confidentiality and security of information transfer. Information of the 2-dimensional code can be passed in real time. The users can edit and modify the content at any time, and people who are allowed to acquire the information can see the changes immediately.

The 2-dimensional bar code is applicable to paper, metal, plastic, wood, ceramic, porcelain, stone and red stoneware.

Usage of the 2-dimensional bar code includes the following steps.
Step 1: generate an editable intelligent 2-dimensional bar code randomly by the 2-dimensional bar code system background;
Step 2: make the 2-dimensional bar code on necessary materials in different forms of presentation and application;
Step 3: by scanning the code with the mobile device, the user will see the editing login interface.

The 2-dimensional bar code has the following forms of presentation and application.
(1) Print the 2-dimensional bar code on all kinds of materials by directly using the printing technology;
(2) Make code on metal materials by using luminance difference between glossy face and the rough face of the metal;
(3) Carve the code on the material surface;
(4) Engrave the code on relevant materials by using hollow-cutting technique;
(5) Inlay or paste the code on other materials by using inlaying technique;
(6) Burn the 2-dimensional bar code pattern on relevant materials by suing the technique of laser engraving.

Step 1, generating an editable intelligent 2-dimensional bar code, includes the following specific procedures.

A. The user inputs the application type. Input one or more pieces of identifying information people who are allowed to acquire the information. Then, the user can enter the editing page;

B. The user can edit the content based on the requirements or can select relevant editing template to make individualized content of the intelligent two-dimensional code;

C. The user can add video or audio files as needed;

D. The user can add, cut or modify the images or text as needed;

E. After editing, the user can “click issuing”. People who are allowed to acquire the information can view it by scanning the code with their mobile devices.

The application types include birthday congratulations, holiday greetings, wedding wishes and graduation congratulations;

Identifying information includes WeChat ID, ID card, telephone number and email address.

The above is a detailed explanation of the technical scheme of this invention. Technical personnel in this field can see that the above embodiments are modifications or alternative approaches. These modifications or improvements are within the protection scope required by this invention on the basis of adhering to spirit of this invention.

1. An intelligent 2-dimensional bar code capable of being edited by a user, comprising:
a mobile device;
a scanable 2-dimensional bar code;
vacant value assignment, wherein can modify content for certain purposes at any time;
wherein the 2-dimensional bar code has video, audio, image and character functions;
wherein editing interface of the 2-dimensional bar code is clear and simple and has an independent editing and operating platform and background making it easy to edit and operate with two editing modes, modular mode and free mode.

2. The bar code of claim 1, further comprising a capability to perform a real-time transfer of the 2-dimensional bar code information, wherein
a user can edit content at any time; and
a person with a permission to access the information is allowed to view the edited content in real time by scanning the bar code.

3. The bar code of claim 1, further comprising:
secured content accessible to certain users scanning the code; and
security of an information transfer.

4. The bar code of claim 1, wherein the bar code is applicable to a group of solid materials, the group consisting of paper, metal, plastic, wood, ceramic, porcelain, stone, and red stoneware.

5. (canceled)

6. (canceled)

7. (canceled)

8. (canceled)

9. A method of using a 2-dimensional bar code capable of being edited by a user comprising the steps of:
generating an editable intelligent 2-dimensional bar code randomly by a 2-dimensional bar code background;
imprinting the 2-dimensional bar code on a material; and
scanning the 2-dimensional bar code with a mobile scanning device with an editing login interface.

10. The method of claim 9, wherein the imprinting step comprises use a printing technology of the group of printing technologies consisting of:
exploiting a luminance difference of a metal between a glossy surface and a rough surface;
carving;
engraving by using hollow-cutting;
engraving by using laser engraving
inlaying; or
burning.

11. The method of claim 9, further comprising steps:
imputing an identifier distinguishing the user with permission to access an editing template from a person with permission to access information but restricted from editing information encoded by the bar code;
editing content wherein the user edits the content; and
issuing the content for access to the person with permission to access information.

12. The method of claim 11, wherein the content comprises file types from the group of file types consisting of: text files, video files, and audio files.

13. The method of claim 11, wherein the user or the person scans the bar code with a mobile device.

14. The method of claim 11, wherein the content comprises a message from the group of messages consisting of: birthday congratulations, holiday greetings, wedding wishes, and graduation congratulations.

15. The method of claim 11, wherein the identifier comprises a datum from the group of data consisting of: a WeChat ID, an ID card, a telephone number, and an email address.
